(19) United States
(12) Patent Application Publication
(10) Pub. No.: US 2009/0238112 A1
(43) Pub. Date: Sep. 24, 2009

(54) Apparatus and method for location information service of terminal in broadband wireless communication system

(75) Inventors: Jong-Woo Hong, Seoul (KR); Sung-Won Lee, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/381,569

(22) Filed: Mar. 13, 2009

(30) Foreign Application Priority Data
Mar. 19, 2008 (KR) 10-2008-0025552

(51) Int. Cl. H04W 24/00

(52) U.S. Cl. 370/328

(57) ABSTRACT

An apparatus and a method for a location information service of a terminal in a broadband wireless communication system re provided. The method includes receiving a first location information request message requesting location information of the MS from an Internet Service Provider (ISP) server; forwarding the first location information request message to a DataBase (DB) which stores the location information of the MS; receiving a first location information response message comprising the location information of the MS from the DB; and forwarding the received first location information response message to the ISP server. Hence, the location information service of various requirements based on the accuracy or the time can be provided. Further, new services or various values added can be created.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Mar. 19, 2008 and assigned Serial No. 10-2008-0025552, the entire disclosure of which is hereby incorporated by reference.

### TECHNICAL FIELD OF THE INVENTION

The present invention relates generally to a location information service. More particularly, the present invention relates to an apparatus and a method for a location information service of a terminal in a broadband wireless communication system.

### BACKGROUND OF THE INVENTION

In a conventional location information service, for an Internet Service Provider (ISP) server to acquire location information of a terminal, the ISP server needs to transmit a signal to the terminal. Naturally, the location information service can provide only the standardized service which takes a certain time and cannot provide services of various requirements according to accuracy or time.

In other words, to acquire the location information of the terminal, the ISP server has to transmit the signal by searching for the terminal. As the ISP server cannot utilize a Database (DB), there is no way to attain the location information within a short time using the pre-stored location information of the terminal. In addition, when the ISP server intends to acquire the accurate or the cell-based location information of the terminal, there is no way to acquire the differentiated location information of the terminal according to the accuracy because an access control router has no paging function based on the active state of the terminal.

### SUMMARY OF THE INVENTION

To address the above-discussed deficiencies of the prior art, it is a primary aspect of the present invention to address at least the above mentioned problems and/or disadvantages and to provide at least the advantages described below. Accordingly, an aspect of the present invention is to provide an apparatus and a method for a location information service of a terminal in a broadband wireless communication system.

Another aspect of the present invention is to provide an apparatus and a method for a location information service of various requirements based on accuracy or time in a broadband wireless communication system.

Yet another aspect of the present invention is to provide an apparatus and a method for, when an Internet Service Provider (ISP) server requests location information of a terminal, responding a location information request demanding a prompt response immediately by retrieving location information of the corresponding terminal from a database, and responding a location information request demanding a differentiated response based on accuracy by acquiring accurate current location information of the terminal through a paging procedure at an Access Control Router (ACR) or by retrieving cell-based location information without the paging procedure in a broadband wireless communication system.

According to one aspect of the present invention, a method for a location information service of a Mobile Station (MS) at a service interface server in a wireless communication system includes receiving a first location information request message requesting location information of the MS from an ISP server; forwarding the first location information request message to a DB that stores the location information of the MS; receiving a first location information response message comprising the location information of the MS from the DB; and forwarding the received first location information response message to the ISP server.

According to another aspect of the present invention, a method for a location information service of an MS at an ACR in a wireless communication system includes receiving a location information request message requesting the location information of the MS from a location server; searching an RAS of the MS; and sending a first location information response message comprising information of the searched RAS to the location server.

According to yet another aspect of the present invention, an apparatus for a location information service of an MS in a wireless communication system includes a DB for storing the location information of the MS; and a service interface server for, when receiving a first location information request message requesting location information of the MS from an ISP server, forwarding the first location information request message to the DB, and when receiving a first location information response message comprising the location information of the MS from the DB, forwarding the received first location information response message to the ISP server.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network of a broadband wireless communication system according to an exemplary embodiment of the present invention;

FIG. 2 illustrate signal flows for storing location information of a MS to a database in the broadband wireless communication system according to an exemplary embodiment of the present invention;

FIG. 3 illustrates signal flows for servicing the location information of the MS in the broadband wireless communication system according to an exemplary embodiment of the present invention;

FIG. 4 illustrates operations of a universal service interface server for servicing the location information of the MS in the broadband wireless communication system according to an exemplary embodiment of the present invention; and

FIG. 5 illustrates operations of an access control router for servicing the location information of the MS in the broadband wireless communication system according to an exemplary embodiment of the present invention.

Throughout the drawings, like reference numerals will be understood to refer to like parts, components and structures.

### DETAILED DESCRIPTION OF THE INVENTION

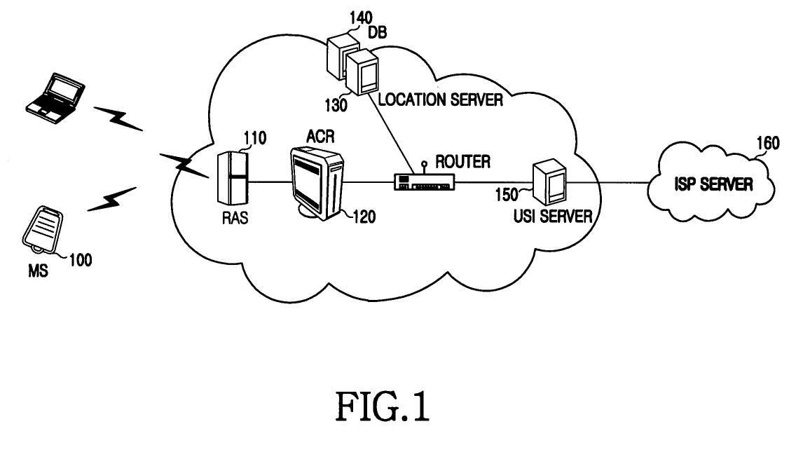

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide an apparatus and a method for a location information service of a terminal in a broadband wireless communication system.

Herein, the broadband wireless communication system represents Worldwide Interoperability for Microwave Access (WiMAX), Institute of Electrical and Electronics Engineers (IEEE) 802.16 and 3rd Generation Partnership Project (3GPP) Long Term Evolution (LTE), 3GPP2 Ultra Mobile Broadband (UMB) and exiting Code Division Multiple Access (CDMA) 2000 1x/1x EVolution-Data Optimized (EV-DO), and Wideband Code Division Multiple Access (WCDMA)/High-Speed Packet Access (HSPA). In what follows, while the WiMAX is illustrated by way of example, the present invention is applicable to other broadband wireless communication technologies.

While a server for servicing a user using location information is an Internet Service Provider (ISP) server, the present invention is applicable to every server which services the user using the location information.

FIG. 1 depicts a network of a broadband wireless communication system according to an exemplary embodiment of the present invention.

The broadband wireless communication system includes MS 100, a Radio Access Station (RAS) or Base Station (BS) 110, an ACR or Access Service Network-GateWay (ASN-GW) 120, a location server 130, DB 140, a Universal Service Interface (USI) server 150, and an ISP server 160.

The ISP server 160 represents an Internet service provider company (e.g., Google and Yahoo). The ISP server 160 offers various services (e.g., Find Friends) to a user using location information of the MS 100. Herein, the location information of the MS 100 is requested to and provided from the USI server 150.

The USI server 150 openly provides the function of the broadband wireless communication network to the ISP server 160 and charges a fee for that. In addition to typical functions, when the ISP server 160 requests the location information of the MS 100, the USI server 150 offers location information of various requirements to the ISP server 160 based on accuracy or time. For example, for the location information request for a prompt response, the USI server 150 offers the location information of the MS 100 pre-stored to the DB 140 to the ISP server 160 in association with the DB 140. For the location information request for a differentiated response based on the accuracy, the USI server 150 offers cell-based location information or accurate current location information in association with the ACR 120 through the location server 130.

The DB 140 stores the location information of the pre-registered MS 100. According to the location information request from the USI server 150, the DB 140 retrieves and provides the location information of the MS 100 to the USI server 150.

The location server 130, which is a server for the location information service, requests the location information of the MS 100 to the ACR 120 in response to the location information request from the USI server 150, receives the location information of the MS 100 from the ACR 120, and forwards the location information to the USI server 150. In response to a DB update request of the USI server 150, the location server 130 updates the location information of the MS 100 registered to the DB 140 on a periodic basis or only when the location information of the MS 100 changes.

The ACR 120 manages connection and mobility of the MS 100. In addition to its typical functions, the ACR 120 retrieves and offers the location information of the MS 100 to the location server 130 in response to the location information request of the location server 130. In particular, depending on whether the MS 100 is active or not, the ACR 120 retrieves and offers the cell-based location information or the accurate current location information to the location server 130. When the MS 100 is active, the ACR 120 requests a paging procedure with the MS 100 to the RAS 110, receives the accurate current location information of the MS 100 from the RAS 110 according to the paging procedure request, and forwards the received location information to the location server 130. In contrast, when the MS 100 is not active, the ACR 120 retrieves the cell-based location information without the paging procedure and offers the location information to the location server 130.

The RAS 110 provides the radio connection to the MS 100. The RAS 110 performs the paging with the MS 100 according to the paging procedure request from the ACR 120, obtains the accurate current location information of the MS 100, and offers the location information to the ACR 120.

The MS 100 represents a mobile phone, a Personal Digital Assistance (PDA), a Portable Multimedia Player (PMP), and a note-Personal Computer (PC) supporting the broadband wireless communication system.

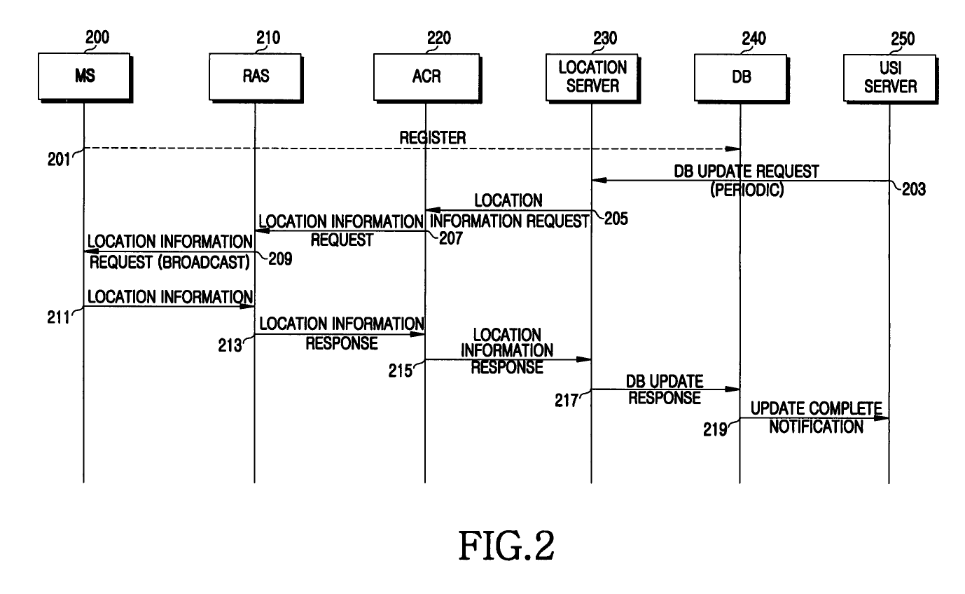

FIG. 2 is a signal flow diagram for storing the location information of the MS to the DB in the broadband wireless communication system according to an exemplary embodiment of the present invention.

The MS 200 pre-registers and stores its location information to the DB 240 in step 201.

In step 203, the USI server 250 transmits a DB update request message to the location server 230 to request the periodic update of the location information of every MS 200 pre-registered to the DB 240. The location server 230 sends a location information request message to the ACR 220 to request the location information of every MS 200 in step 205. Receiving the location information request message, the ACR 220 forwards the location information request message to the RAS 210 in step 207. In step 209, the RAS 210 broadcasts the location information request message to every MS 200 currently connected to the RAS 210.

In step 211, the MS 200 receiving the broadcast location information request message sends a response signal to the RAS 210 to inform of its location. That is, the MS 200 transmits its location information to the RAS 210. The RAS 210 generates a location information response message including the location information of the MS 200 and sends the response message to the ACR 220 in step 213. Likewise, the ACR 220 forwards the location information response message to the location server 230 in step 215. The location server 230 sends a DB update response message including the location information of the MS 200 to the DB 240 in step 217. The DB 240 updates the location information of the corresponding MS 200 using the location information and then sends an update complete notification message to the USI server 250 in step 219.

In FIG. 2, the location information of the MSs registered to the DB is updated on the periodic basis. Alternatively, the location information of the corresponding MS may be updated only when the location information is changed. In this case, the DB update request message sent from the USI server 250 to the location server 230 requests to update only the changed location information of the corresponding MS among the MSs 200 pre-registered to the DB 240. The subsequent steps are substantially the same as in FIG. 2. The only difference lies in that the MS 200 receiving the broadcast location information request message waits until its location information is changed and sends the response signal to the RAS 210 to inform of its changed location when its location is changed.

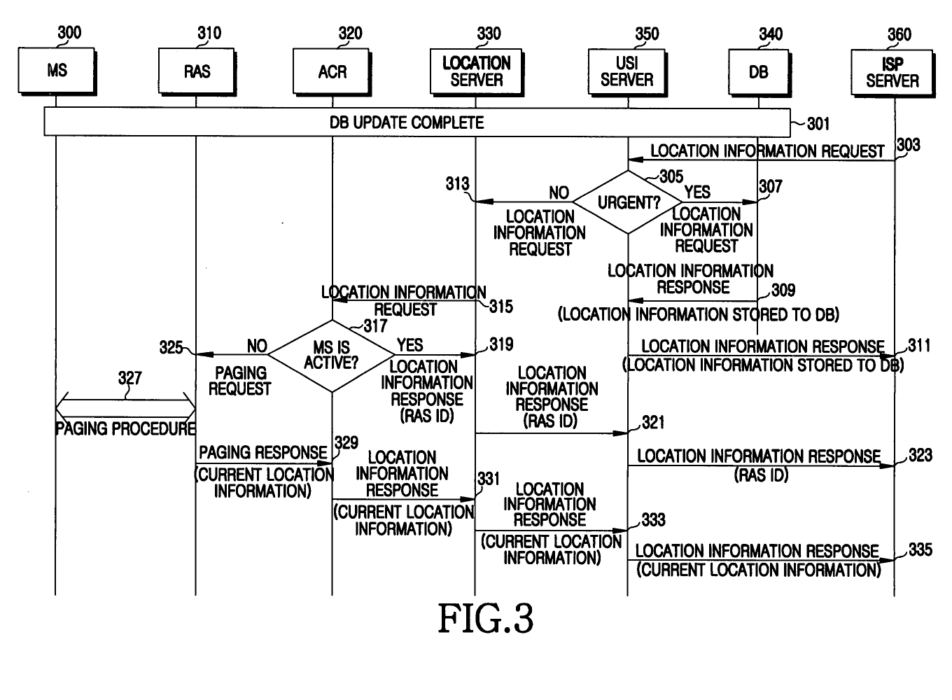

FIG. 3 is a signal flow diagram for servicing the location information of the MS in the broadband wireless communication system according to an exemplary embodiment of the present invention.

In step 301, the MS 300 stores its location information to the DB 340, updates the location information, and completes the update of the DB 340 as in FIG. 2.

In step 303, the ISP server 360 sends a location information request message to the USI server 350 to request the transmission of the location information of one or more MSs 300. The USI server 350 checks whether the location information request message is an urgent message which requests a prompt response based on the time in step 305. The USI server 350 can determine the urgent message based on the location information request message received within a certain time after the DB 340 is updated, and determine the non-urgent message based on the location information request message received in the certain time.

When the location information request message is the urgent message requesting the prompt response in step 305, the USI server 350 sends the location information request message to the DB 340 in step 307. The DB 340 retrieves the pre-stored location information of the MS 300 pre-stored to the DB 340 and sends the location information response message including the retrieved location information to the USI server 350 in step 309. The USI server 350 forwards the location information response message to the ISP server 360 in step 311. Hence, the ISP server 360 can obtain the location information of the MS 300 using the DB 340.

By contrast, when the location information request message is not the urgent message demanding the prompt response in step 305, the USI server 350 forwards the location information request message of the ISP server 360 to the location server 330 in step 313. Likewise, the location server 330 forwards the location information request message to the ACR 320 in step 315.

The ACR 320 checks whether the MS 300 is active or not in step 317. When the MS 300 is active in step 317, the ACR 320 identifies the RAS of the MS 300 and sends the location information response message including an Identifier (ID) of the identified RAS to the location server 330 in step 319. The location server 330 forwards the location information response message to the USI server 350 in step 321. Similarly, the USI server 350 forwards the location information response message to the ISP server 360 in step 323. Thus, the ISP server 360 can acquire the location information of the MS 300 based on the RAS.

By contrast, when the MS 300 is not active in step 317, the ACR 320 sends the paging request message of the MS 300 to the RAS 310 in step 325. The RAS 310 acquires the accurate current location information of the MS 300 through the paging procedure with the MS 300 in step 327 and sends the paging response message including the accurate current location information of the MS 300 to the ACR 320 in step 329. The ACR 320 sends the location information response message to the location server 330 in step 331. Likewise, the location server 330 forwards the location information response message to the USI server 350 in step 333 and the USI server 350 forwards the location information response message to the ISP server 360 in step 335. Hence, the ISP server 360 can acquire the accurate current location information of the MS 300.

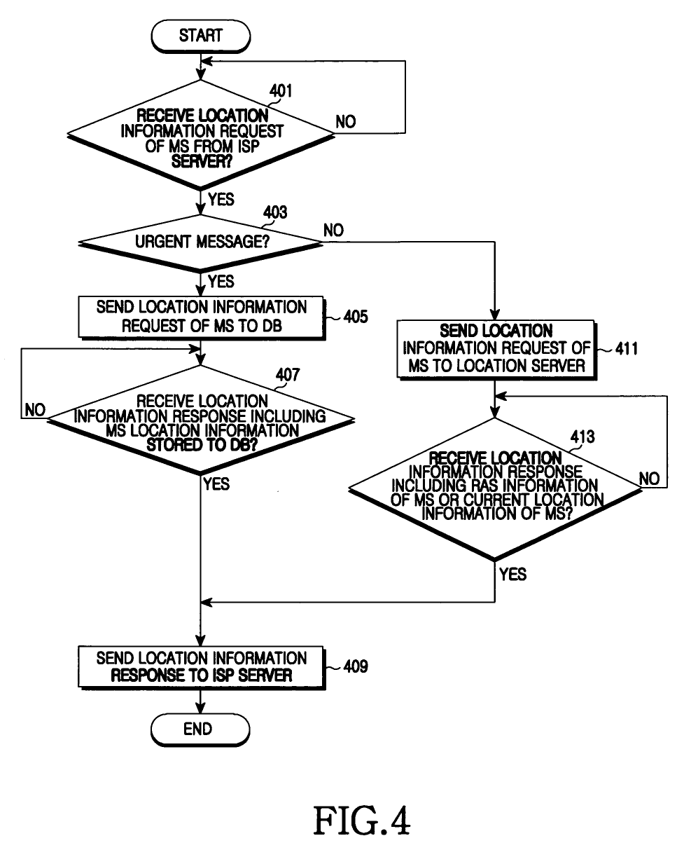

FIG. 4 is a flowchart outlining the operations of the USI server for servicing the location information of the MS in the broadband wireless communication system according to an exemplary embodiment of the present invention.

In step 401, the USI server checks whether the location information request message requesting the transmission of the location information of one or more MSs is received from the ISP server. When receiving the location information request message, the USI server checks whether the location information request message is the urgent message demanding the prompt response based on time in step 403. Herein, the USI server can determine the urgent message based on the location information request message received within a certain time after the DB is updated, and determine the non-urgent message based on the location information request message received in the certain time.

When the location information request message is the urgent message requesting the prompt response in step 403, the USI server sends the location information request message to the DB in step 405. In step 407, the USI server checks whether the location information response message including the location information of the corresponding MS pre-stored to the DB is received from the DB. When receiving the location information response message, the USI server forwards the location information response message to the ISP server in step 409. Hence, the ISP server can obtain the location information of the MS by use of the DB.

By contrast, when the location information request message is not the urgent message requesting the prompt response in step 403, the USI server forwards the location information request message of the ISP server to the location server in step 411. In step 413, the USI server checks whether the location information response message including the information of the RAS of the MS or the accurate current location information of the MS is received from the location server. When receiving the location information response message, the USI server forwards the location information response message to the ISP server in step 409. Hence, the ISP server can obtain the MS location information based on the RAS or the accurate current location information of the MS.

Next, the USI server finishes this process.

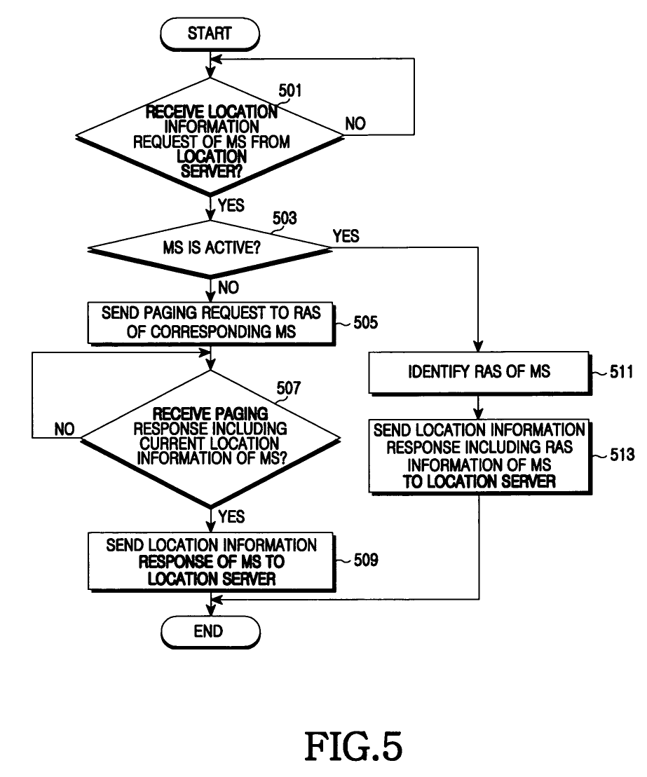

FIG. 5 is a flowchart outlining the operations of the ACR for servicing the location information of the MS in the broadband wireless communication system according to an exemplary embodiment of the present invention.

In step 501, the ACR checks whether the location information request message requesting the transmission of the location information of one or more MSs is received from the location server. When receiving the location information request message, the ACR checks whether the MS is active or not in step 503.

When the MS is active in step 503, the ACR identifies the RAS of the MS in step 511 and sends the location information response message including the information of the identified RAS to the location server in step 513. Thus, the ISP server can obtain the location information of the MS based on the RAS.

When the MS is not active in step 503, the ACR sends the MS paging request message to the RAS of the MS in step 505 and checks whether the paging response message including the accurate current location information of the MS is received from the RAS in step 507. Upon receiving the paging response message, the ACR sends the location information response message including the accurate current location information of the MS to the location server in step 509. Thus, the ISP server can obtain the accurate current location information of the MS.

Next, the ACR finishes this process.

In this embodiment of the present invention, the USI server and the ACR determine whether the location information request message from the ISP server is the urgent message demanding the prompt response and whether the MS is active or not, retrieve and provide the location information of the corresponding MS pre-stored DB to the ISP server or provide the MS location information based on the RAS or the accurate current location information of the MS. Alternatively, by including information relating to the service type to the location information request message sent by the ISP server, the USI server and the ACR may provide the location information service of various requirements using the information relating to the service type. The information of the service type can include information relating to a service demanding the prompt response, a service demanding the RAS based location information, and a service demanding the accurate current location information of the MS. Accordingly, when receiving the location information request message including the service information demanding the prompt response, the USI server retrieves and offers the location information of the corresponding MS pre-stored to the DB. When receiving the location information request message including the other service information, the USI server can forward the corresponding location information request message to the ACR. Herein, when the received location information request message includes the other service information and the corresponding service demands the RAS based location information, the ACR can retrieve and offer the RAS information of the corresponding MS. When the corresponding service demands the accurate current location information of the MS, the ACR can acquire and provide the accurate current location information of the MS through the paging procedure.

When the ISP server requests the location information of the MS in the broadband wireless communication system, the location information request demanding the prompt response is responded immediately by retrieving the location information of the corresponding MS in the DB. The location information request demanding the differentiated response based on the accuracy is responded by acquiring the accurate current location information of the MS through the paging procedure at the ACR or by retrieving the cell-based location information without the paging procedure. Therefore, the location information service of various requirements based on the accuracy or the time can be provided. Further, new services or various values added can be created.

Based on the location information of the MSs stored to the DB, the flows or the time-based traffic of the corresponding MSs can be acquired and utilized for the efficiency network resource management. Since the location information service is offered without the signal delivery from the ISP server to the MS, the network resources can be saved and utilized efficiently. The cell-based location information can be applied to other services such as advertisement, status acquisition of MSs, and time-based integration of a particular RAS. The accurate location information of the MS using the paging can be used to find missing children or to locate friends.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for a location information service of a Mobile Station (MS) at a service interface server in a wireless communication system, the method comprising:
receiving a first location information request message requesting location information of the MS from an Internet Service Provider (ISP) server;
forwarding the first location information request message to a DataBase (DB) which stores the location information of the MS;
receiving a first location information response message comprising the location information of the MS from the DB; and
forwarding the received first location information response message to the ISP server.

2. The method of claim 1, wherein the first location information request message demands a prompt response based on time.

3. The method of claim 2, further comprising:
when the first location information request message does not demand the prompt response based on the time, forwarding the first location information request message to a location server;
receiving a second location information response message which comprises at least one of cell-based location information of the MS or accurate current location information of the MS, from the location server; and
forwarding the received second location information response message to the ISP server.

4. The method of claim 3, wherein the cell-based location information is a Radio Access Station (RAS) identifier.

5. The method of clam 1, wherein the first location information request message is a location information request message received within a certain time after the DB is updated.

6. The method of claim 1, further comprising:
sending a DB update request message which requests to update the location information of the MS, to the location server; and
receiving an update complete notification message informing of a location information update completion of the MS, from the DB,
wherein the location server sends a second location information request message requesting the location information of the MS to the RAS via an Access Control Router (ACR), the RAS sends a third location information response message comprising the location information of the MS to the location server via the ACR, the location server sends a DB update response message comprising the location information of the MS to the DB, and the DB forwards the update complete notification message to the service interface server after updating the location information of the MS.

7. The method of claim 6, wherein the DB update request message is a message requesting to update the location information of the MS on a periodic basis or only when the location information of the MS is changed.

8. A method for a location information service of a Mobile Station (MS) at an Access Control Router (ACR) in a wireless communication system, the method comprising:
receiving a location information request message requesting the location information of the MS from a location server;
searching a Radio Access Station (RAS) of the MS; and
sending a first location information response message comprising information of the searched RAS to the location server.

9. The method of claim 8, further comprising:
determining whether the MS is active or not.

10. The method of claim 9, further comprising:
when the MS is not active, sending a paging request message requesting a paging procedure with the MS, to the RAS of the MS;
receiving a paging response message comprising the location information of the MS from the RAS, the information acquired through the paging procedure with the MS; and
sending a second location information response message comprising the location information of the MS to the location server.

11. An apparatus for a location information service of a Mobile Station (MS) in a wireless communication system, the apparatus comprising:
a DataBase (DB) for storing the location information of the MS; and
a service interface server for, when receiving a first location information request message requesting location information of the MS from an Internet Service Provider (ISP) server, forwarding the first location information request message to the DB, and when receiving a first location information response message comprising the location information of the MS from the DB, forwarding the received first location information response message to the ISP server.

12. The apparatus of claim 11, wherein the first location information request message demands a prompt response based on time.

13. The apparatus of claim 12, wherein the service interface server forwards the first location information request message to a location server when the first location information request message does not demand the prompt response based on the time, receives a second location information response message which comprises at least one of cell-based location information of the MS or accurate current location information of the MS, from the location server, and forwards the received second location information response message to the ISP server.

14. The apparatus of claim 13, wherein the cell-based location information is a Radio Access Station (RAS) identifier.

15. The apparatus of clam 13, further comprising:
the location server for forwarding the first location information request message of the service interface server to an Access Control Router (ACR) and forwarding the second location information response message of the ACR to the service interface server; and
the ACR for, when receiving the first location information request message, forwarding the second location information response message which comprises at least one of cell-based location information of the MS or accurate current location information of the MS, to the location server.

16. The apparatus of claim 15, wherein the ACR determines whether the MS is active or not, searches an RAS of the MS when the MS is active, and sends the second location information response message comprising information relating to the searched RAS to the location server, and
when the MS is not active, the ACR sends a paging request message requesting a paging procedure with the MS, to the RAS of the MS, receives a paging response message comprising the location information of the MS from the RAS, the information acquired through the paging procedure with the MS, and sends the second location information response message comprising the accurate current location information of the MS to the location server.

17. The apparatus of claim 11, wherein the first location information request message is a location information request message received within a certain time after the DB is updated.

18. The apparatus of claim 11, wherein the service interface server sends a DB update request message which requests to update the location information of the MS, to the location server, and receives an update complete notification message informing of a location information update completion of the MS, from the DB,
the location server sends the second location information request message requesting the location information of the MS to the RAS via an Access Control Router (ACR), receives a third location information response message comprising the location information of the MS from the RAS via the ACR, and sends a DB update response message comprising the location information of the MS to the DB, and
the DB forwards the update complete notification message to the service interface server after updating the location information of the MS.

19. The apparatus of claim 18, wherein the DB update request message is a message requesting to update location information of the MS on a periodic basis or only when the location information of the MS is changed.
